(19) United States
(12) Patent Application Publication
(10) Pub. No.: US 2012/0321462 A1
(43) Pub. Date: Dec. 20, 2012

(54) WIND TURBINE ROTOR BLADE WITH STALL COMPENSATION

(75) Inventors: John Bruce McPherson, Hyannisport, MA (US); Todd R. Quackenbush, Ringoes, NJ (US); Susan S. McPherson, Hyannis Port, MA (US)

(73) Assignee: MCPHERSON PERFORMANCE BLADE LLC, Lawrenceville, NJ (US)

(21) Appl. No.: 13/414,229

(22) Filed: Mar. 7, 2012

Related U.S. Application Data
(60) Provisional application No. 61/449,900, filed on Mar. 7, 2011.

(51) Int. Cl. F03D 7/04; F03D 1/06

(52) U.S. Cl. 416/1; 416/147; 416/223 R

(57) ABSTRACT

An improved wind turbine blade design is disclosed. The wind turbine blade includes a plurality of pivotable blade segments. Each blade segment has a leading edge segment and a trailing edge segment. At least one sensor is configured to measure a performance condition associated with the blade segment. An actuator is configured to pivot the blade segment to change an angle of attack based on the performance condition.

### CROSS-REFERENCE TO PRIOR FILED APPLICATIONS

This application claims priority to earlier filed U.S. provisional application No. 61/449,900 filed Mar. 7, 2011, which is incorporated herein in its entirety.

### FIELD OF INVENTION

This invention relates wind turbines, and especially relates to techniques for improving blade performance and compensating for local stall conditions appearing along a rotor blade.

### BACKGROUND

A wind turbine generally converts kinetic energy from wind into mechanical energy. The mechanical energy can be used for a variety of purposes. For example, a wind turbine can be used to drive machinery, for grinding grain or pumping water. In many applications, a wind turbine is coupled to an electrical generator. Smaller wind turbines are used for applications such as battery charging or auxiliary power on sailing boats. Larger grid-connected arrays of turbines (e.g., wind farms) are becoming an increasingly large source of commercial electric power.

Large scale wind turbine operations produce an audible “swish” sound, low-frequency sound and ultra low-frequency sound or “infrasound”. People living in close proximity to wind farms are often disturbed by the sound/vibration. Current research suggests that such sound/vibration may also result in undesirable physiological or psychological effects. Such adverse effects are often referred to as Wind Turbine Syndrome (WTS). It is therefore desirable to provide a wind turbine blade design with improved performance that may also reduce undesirable sound generation of a wind turbine system.

### SUMMARY OF THE INVENTION

A wind turbine blade with improved performance is disclosed herein. The wind turbine blade may have a plurality of pivotable blade segments each having a leading edge segment and a trailing edge segment. A sensor is configured to detect a performance condition associated with at least one of the blade segments. An actuator is configured to pivot the blade segment to change an angle of attack based on the performance condition. At least one sensor may be associated with each pivotable blade segment. A processor may be coupled to the sensor, the processor being configured to read the sensor and drive the actuator to change the angle of attack of the blade segment based on the sensor reading.

The sensor may be configured to measure pressures associated with at least one of an upper and lower surface of the blade segment. The sensor may be configured to measure flow associated with at least one of an upper and lower surface of the blade segment. The sensor may be configured to measure rotational speed.

The segments may have a home position and the actuator may be configured to move the segments to the home position on a condition that the rotational speed exceeds a capacity threshold. The blade may include a tuburcle coupled to the leading edge segment of at least one blade segment. The blade may include a main spar disposed along a major axis of the wind turbine blade, the pivotable blade segments being configured to pivot around the main spar.

Each pivotable blade segment may have a home position and may be adjustable by a number of degrees on either side of the home position. The blade may be configured with four segments configured at 3°, 3°, 6° and 6° above a home position. The blade may be configured with two segments configured at 3° and 6°above a home position. The blade may include a left and right fence associated with each pivotable blade segment.

A method of improving the performance of a wind turbine blade is also disclosed. The method may include providing a wind turbine blade with a plurality of pivotable blade segments each having a leading edge segment and a trailing edge segment; detecting a performance condition associated with at least one of the blade segments, and changing an angle of attack of the blade segment based on the performance condition.

The method may also include measuring pressures associated with at least one of an upper and lower surface of the blade segment to determine the performance condition. The method may also include measuring flow associated with at least one of an upper and lower surface of the blade segment to determine the performance condition. The method may also include measuring rotational speed to determine the performance condition.

The segments may have a home position and segments may be moved to the home position on a condition that the rotational speed exceeds a capacity threshold. Each pivotable blade segment may have a home position and may be adjustable by a number of degrees on either side of the home position. The blade may be configured with four segments initially configured at 3°, 3°, 6° and 6° above a home position. The blade may be configured with two segments initially configured at 3° and 6° above a home position.

A wind turbine blade may also be provided with a plurality of pivotable blade segments each having a leading edge segment and a trailing edge segment, each segment having a home position. A sensor may be configured to detect a performance condition associated with at least one of the blade segments. An actuator may be configured to pivot the blade segment to change an angle of attack to improve blade performance based on the performance condition, the actuator being configured to move to the segments to the home position on a condition that the blade performance exceeds a capacity threshold.

A method of generating power using a wind turbine blade is also disclosed. The method may include providing a wind turbine blade with a plurality of pivotable blade segments each having a leading edge segment and a trailing edge segment; detecting a performance condition associated with at least one of the blade segments, and changing an angle of attack of the blade segment based on the performance condition.

A fixed wind turbine blade is also disclosed. The blade may have a plurality of blade segments each having a leading edge segment and a trailing edge segment, a portion of the blade generally defining a home position, at least one of the segments being displaced from a home position. The blade may be configured with two segments configured at 3° and 6° above a home position.

### BRIEF DESCRIPTION OF THE DRAWINGS

FIG. 1 is a diagram of a horizontal-axis wind turbine;

FIG. 2 is a diagram of a segmented rotor blade;

FIG. 3 is a sectional view of a blade segment taken along section A-A;

FIG. 4 is a sectional view of a blade segment taken along section B-B;

FIG. 5 is a drawing showing additional details of a sample main spar;

FIG. 6 is a flowchart showing basic operation of the processor;

FIGS. 7A and 7B show blade configurations for a simulation model;

FIG. 8A is a diagram of a turbine blade configured with two segments;

FIG. 8B is a diagram of a turbine blade configured with four segments;

FIG. 9 is a graph (turbine power verses wind speed) showing simulation results for several configurations of the blades shown in FIGS. 8A and 8B;

FIG. 10 is a graph (turbine power verses wind speed) showing simulation results for configuration 12 of the blade shown in 8B; and

FIG. 11 is a flow chart showing basic operation of the processor as the blade reaches rated capacity.

### DETAILED DESCRIPTION OF THE EMBODIMENTS

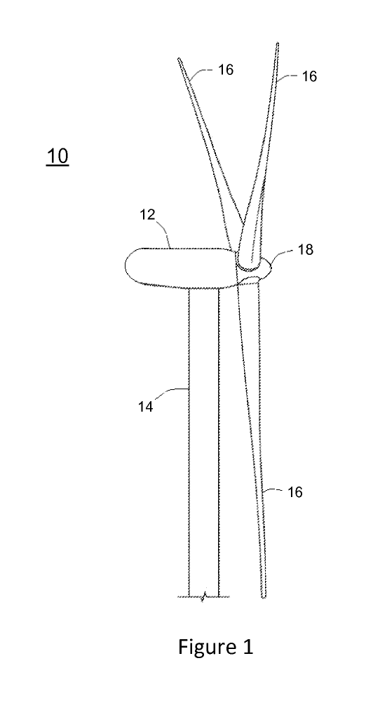

FIG. 1 shows a typical horizontal-axis wind turbine (HAWT) 10 having a nacelle 12 located at the top of a tower 14. It should be understood that this disclosure is applicable to a wide variety of wind turbine designs including but not limited to horizontal and vertical axis designs. The turbine generally includes a plurality of blades 16 coupled to a hub 18. Wind passing over the blades causes the hub 18 to rotate. In this example, a horizontal shaft is coupled to the hub and drives an electrical generator located in the nacelle 12. In some cases, a gear reduction unit is used to drive the electrical generator at the desired speed. Such turbines must be pointed into the wind. The nacelle 12 is typically rotatable as a unit with respect to the tower 14. Small turbines are pointed by a simple wind vane coupled to the nacelle 12. Large turbines generally use a wind sensor coupled with a drive motor to rotate the nacelle 12. Some wind turbines also include a control unit configured to adjust the pitch of the rotor blades. The pitch of an individual rotor blade is generally adjusted to control the aerodynamic performance of the wind turbine.

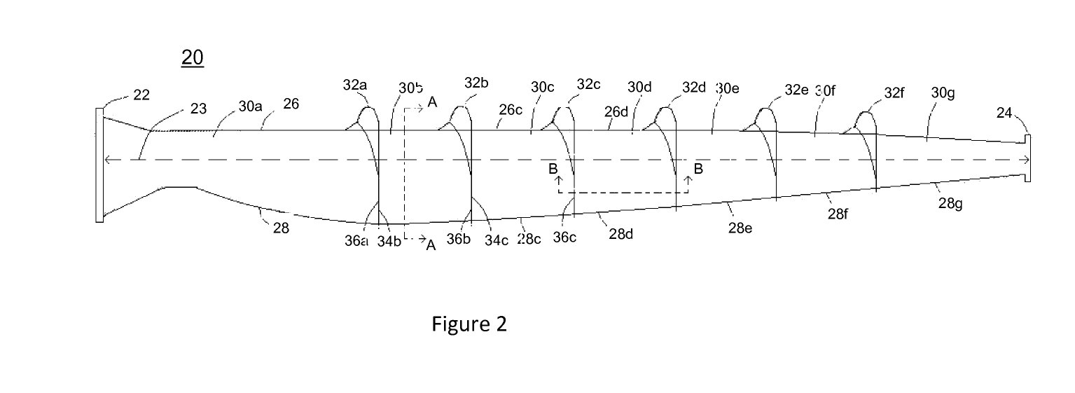

Existing systems lack a mechanism to address small scale disturbances that appear along a rotor blade. FIG. 2 is a diagram of a segmented rotor blade 20 configured to address such small scale disturbances. The rotor blade 20 includes a root 22 and a tip 24. The rotor blade 20 generally has a major axis 23 defined between the root 22 and the tip 24. The rotor blade 20 also includes a leading edge 26 and a trailing edge 28.

The rotor blade 20 is composed of a plurality of blade segments 30 (shown as 30a-30g) that are serially arranged along the major axis 23. At least two of the blade segments 30 are independently pitch controllable as discussed in detail below. Each blade segment 30 includes a leading edge portion or segment and a trailing edge portion or segment. For example, blade segment 30c includes a leading edge segment 26c and a trailing edge segment 28c. Each blade segment 30 can optionally include one or more protrusions or tubercles 32 formed in the leading edge (e.g., shown as 32a-32f) for improving air flow over the blade surface. Each blade segment 30 can also include a left and right fence 34, 36 located on each side of the segment. For example, blade segment 30b includes left fence 34b and a right fence 36b. Fences 34, 36 generally provide a raised edge on opposite sides of the blade segment 30 and assist in maintaining air flow over the segment.

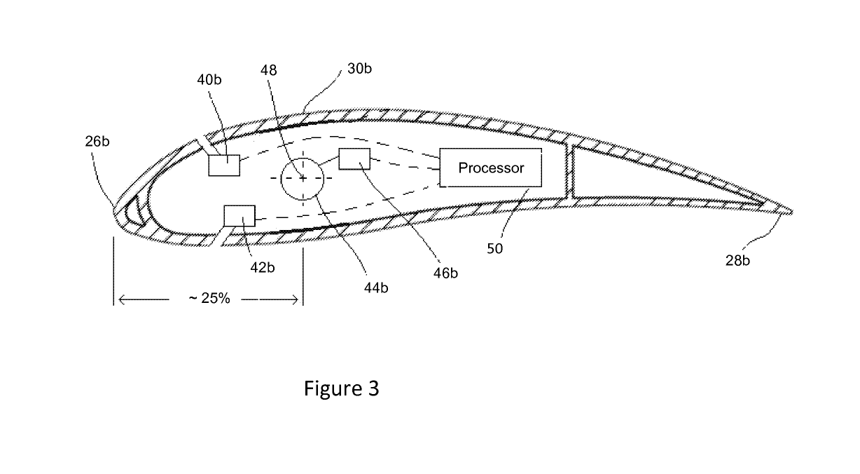

FIG. 3 is a sectional view of blade segment 30b taken along section A-A. Blade segment 30b includes a leading edge segment 26b and a trailing edge segment 28b. A processor 50 is configured to sample one or more sensors to determine a performance condition. In this example, blade segment 30b includes an upper pressure sensor 40b and a lower pressure sensor 42b. The upper and lower pressure sensors 40b, 42b are shown generally in the leading edge portion of the blade segment. It should be understood that a variety of sensor locations are possible including the trailing edge and or several locations along the upper and lower surface of the blade segment. It should also be understood that pressure sensors 40, 42 may also be configured to sense the pressure at several positions above and/or below the wing surface so that several layers of air may be sampled.

Selection and configuration of suitable sensors based on the disclosure contained herein is well within the grasp of those skilled in the art. Suitable sensors may detect pressure and or air flow. Sensors may also be used to detect the rotational speed of the turbine. Sensors may be generally disposed on the upper or lower surface of the blade, or both. The following US patent reference contain applicable sensors and hereby incorporated by reference in their entireties: US Patent Publication No. 2009/0311096 entitled “Method and Apparatus for Measuring Air Flow Condition at a Wind Turbine Blade”, US Patent Publication No. 2010/0143129 entitled “Wind Turbine Blade With Integrated Stall Sensor and Associated Method of Detecting Stall of a Wind Turbine Blade”, US Patent Publication No. 2010/0021296 entitled “Method and Arrangement to Adjust a Pitch of Wind-Turbine-Blades.

Blade segment 30b includes a pivot 44b and an actuator 46b. The pivot is generally centered at the load center 48 of the blade segment. The pivot can be implemented in a variety of forms. The actuator 46b is coupled to the pivot and is configured to rotate the blade segment around the load center 48 thereby changing the angle of attack of the blade segment. The actuator, upper pressure sensor 40b and a lower pressure sensor 42b are coupled to a processor 50. It should be understood that the processor 50 can be located in a variety of locations including within the rotor blade 20 or another remote location, e.g., within a nacelle. Processor 50 is configured to sample pressure sensors 40b, 42b, determine whether a stall condition exists and drive the actuator 46b to compensate lower the angle of attack and reduce or eliminate the stall condition.

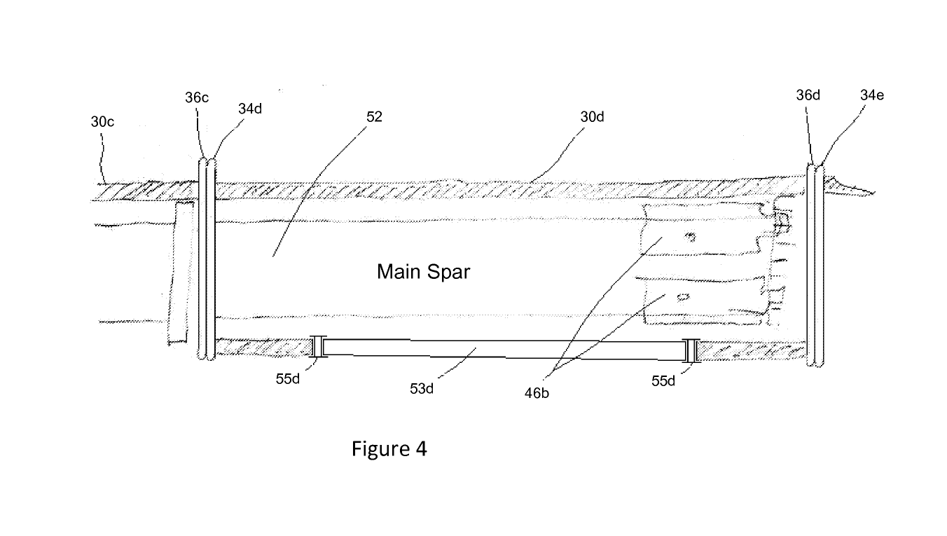

FIG. 4 is a sectional view of blade segment 30d taken along section B-B. The blade segment 30d has a left and right fence 34d, 36d located on each side of the segment. The blade segment pivots around a main spar 52. Actuator 46b is shown as a pair of gear reduced electric motors. It should be understood that a variety of actuators could be used including a variety of electric motors, hydraulic actuators and the like.

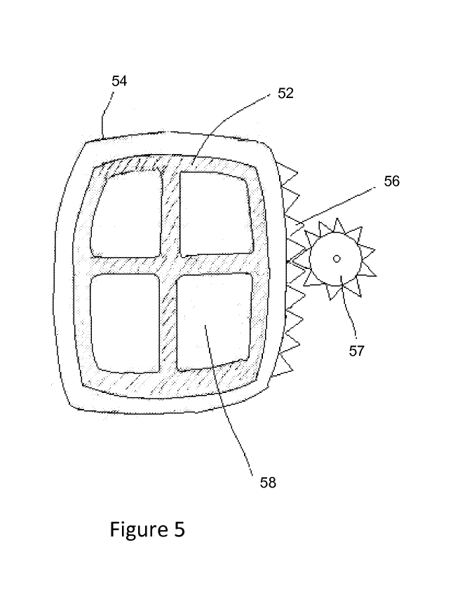

FIG. 5 shows additional details of a sample main spar 50. The main spar 50 can include a gear ring 54. In general, the main spar can be pivotally coupled to the various blade segments. The main spar 50 is generally fixed at the root end of the blade 20 and extends through the last blade segment. The blade segments can include a bearing or sleeve that is configured to allow the blade segment to pivot around the main spar 50. The gear ring is configured to engage a drive motor such that the angular position of the blade segment can be adjusted with respect to the main spar 50. In general, each blade segment has a home position (i.e., no angular offset) and is adjustable by a number of degrees on either side of the home position. As discussed above, a variety of actuators can be used without departing from the scope of this disclosure. The main spar can be configured with a hollow portion configured as a wire chase 58. The wire chase 58 can be configured to carry wires for interconnection of the various system components (e.g., sensors 40, actuators 46 and processor 50).

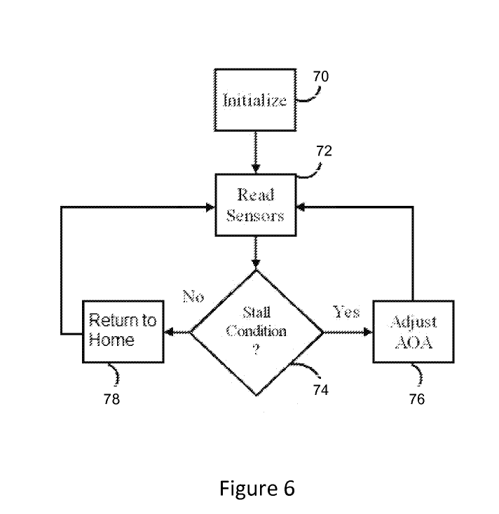

FIG. 6 is a flowchart showing basic operation of the processor 50. It should be understood that the flowcharts contained herein are illustrative only and that other program entry and exit points, time out functions, error checking routines and the like (not shown) would normally be implemented in typical system software. It is also understood that some of the individual blocks may be implemented as part of an iterative process. It is also understood that the system software can be implemented to run continuously. Accordingly any beginning and ending blocks are intended to indicate logical beginning and ending points of a portion of code that can be executed as needed to support continuous system operation. Implementation of these aspects of the invention is readily apparent and well within the grasp of those skilled in the art based on the disclosure herein.

The processor 50 is initialized as shown by block 70. In this example, a single processor is coupled to a plurality of blade segments. Once the processor is initialized, the first movable blade segment (e.g. 30b) is serviced. The sensors 46 associated with the selected blade segment are read as shown by block 72. The sensor readings are evaluated (e.g., sensor readings from the upper and lower surface of the blade segment are compared) as shown by block 74. If a stall condition is detected, then the angle of attack for the given blade segment is reduced. The blade segment can be returned to the home position once the pressure sensors for that segment return to a non-stall or normal condition. If no stall condition is detected, no angular adjustment is made and the next blade segment is selected as shown by block 78. Control then returns to block 72 and the next blade segment is serviced.

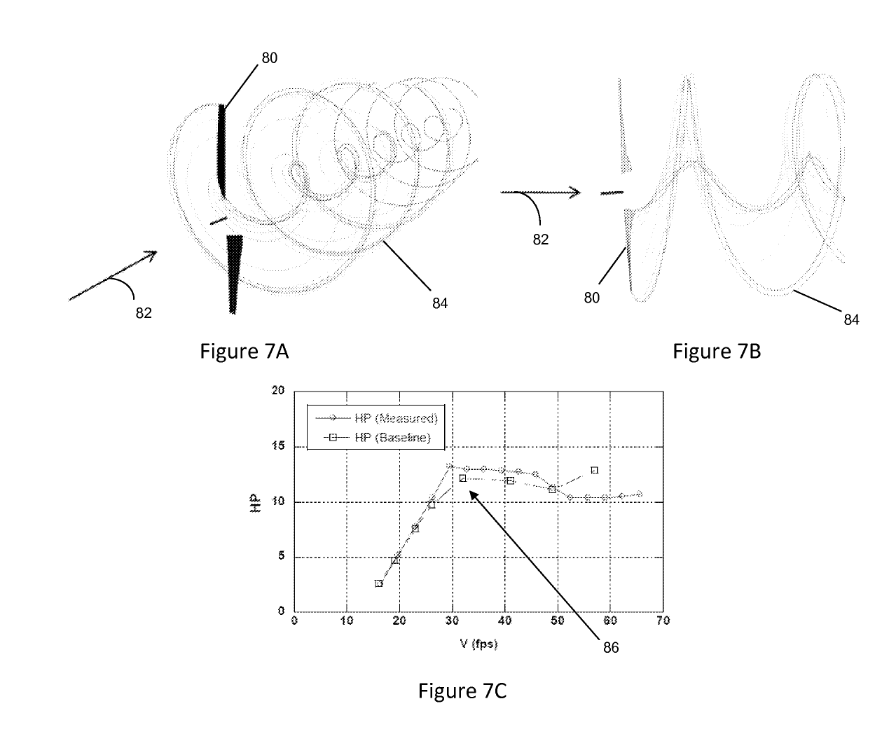

Several simulations were conducted using CHARM (Comprehensive Hierarchical Aeromechanics Rotorcraft Model) simulation software (http://www.continuum-dynamics.com). A public domain wind turbine model was used as shown generally in FIGS. 7A and 7B. The model generally includes a variety of blade parameters including, the number of blades, blade radius, airfoil shape and the like. In this example, the turbine has two blades 80. It should be understood that the number of blades may be varied without departing from the scope of this disclosure. The CHARM software also simulates a variety of environmental conditions including wind conditions, e.g., specific wind speeds and direction as show generally by reference number 82. Based on the selected blade parameters and environmental conditions the CHARM software may generate a simulated wake pattern as shown my reference number 84 as well as other performance related information.

In this example, the model is generally directed to a two bladed 10 KW wind turbine. FIG. 7C is a graph of output power verses turbine velocity. In general, wind turbine blades have a maximum rated speed. Typically, rotor speeds in excess of the maximum rated speed are undesirable. In this example, the maximum rotor speed is approximately 32 fps as shown by reference number 86.

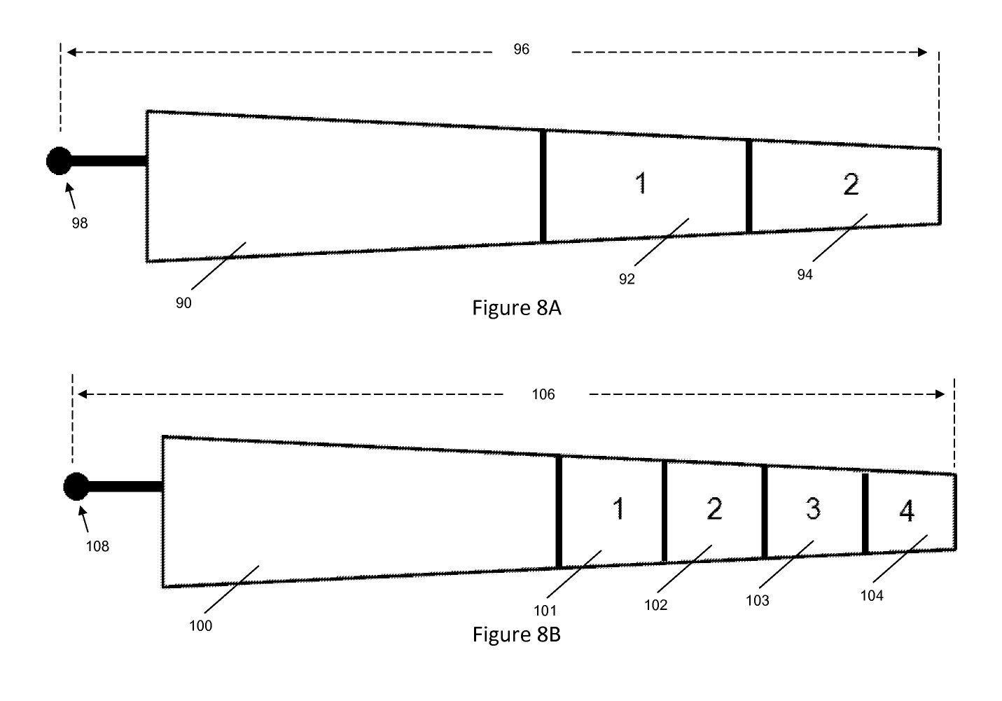

FIGS. 8A and 8B show segmented blade configurations that were used in simulations. FIG. 8A shows a turbine blade 90 configured with two segments 92, 94. Each segment 92, 94 is independently pitch controllable. It should be understood that the blade 90 is coupled to a hub, shown schematically by reference number 98. The blade 90 has a radius shown by reference number 96. In this example, the segmented portion of the blade is confined to the outboard 50% of the radius. FIG. 8B shows a turbine blade 100 configured with four segments 1010, 102, 103 and 104. Each segment 101, 102, 103 and 104 is independently pitch controllable. As noted above, blade 100 is coupled to a hub, shown schematically by reference number 108. The blade 100 has a radius shown by reference number 106. In this example, the segmented portion of the blade is again confined to the outboard 50% of the radius. It should be understood that the number of segments and their location may be varied without departing from the scope of this disclosure.

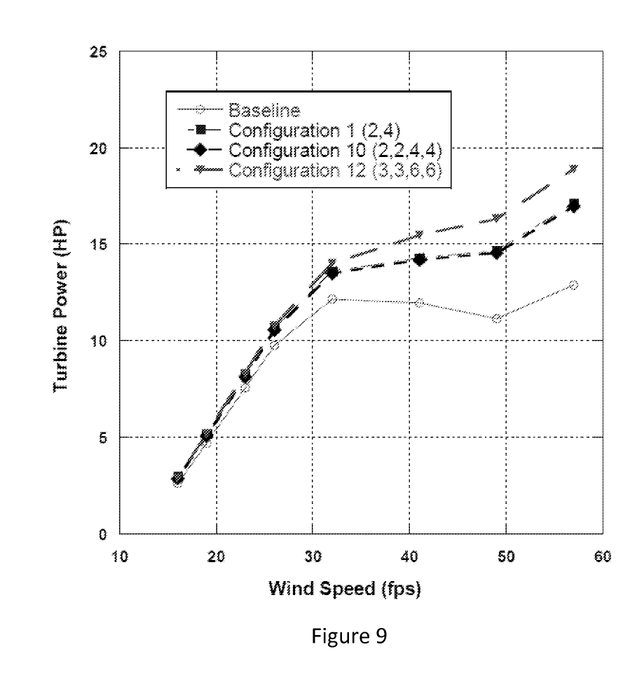

FIG. 9 is a graph (turbine power verses wind speed) showing simulation results for several configurations for the blades shown in FIGS. 8A and 8B. For example configuration 1 is a two segment blade, see e.g., FIG. 8A, with segments 92 and 94 positioned at 2° and 4° above the home position respectively. Configuration 10 is a four segment blade, see e.g., FIG. 8B, with segments 101, 102, 103 and 104 positioned at 2°, 2°, 4° and 4° above the home position respectively. Both configurations 1 and 10 produce improved performance, e.g., increased power output, over the baseline configuration (non-segmented blade). Configurations 1 (2 segments) and 10 (4 segments) are essentially identical in shape. However, configuration 10 may include additional fences and/or tubercles between segments. Configuration 12 is a four segment blade, see e.g., FIG. 8B, with segments 101, 102, 103 and 104 positioned at 3°, 3°, 6° and 6° above the home position respectively. Configuration 12 produces improved performance, e.g., increased power output, over the baseline configuration as well as configurations 1 and 10. It should be understood that a configuration with two segments at 3° and 6° above the home position would perform similarly to Configuration 12. It also should be understood that other segment configurations may also produce desirable results.

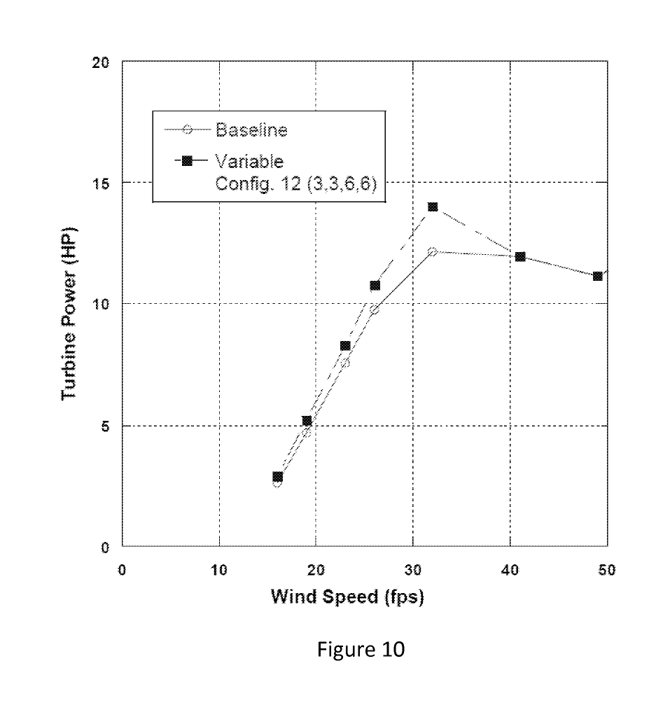

In some cases, improved blade performance of segmented configurations may lead to power levels or rotor speeds in excess of rated capacity. In order to address such issues, it may be desirable to return some or all of the blade segments to the home position once the blade reaches a rated capacity threshold (a percentage of rated capacity). FIG. 10 is a graph (turbine power verses wind speed) showing simulation results for configuration 12 of the blade shown in 8B. In this example, it is assumed that the rated capacity of the blade is 32 fps. For rotor speeds below 32 fps, the segments 101, 102, 103 and 104 are configured at 3°, 3°, 6° and 6° above the home position respectively. For rotor speeds above, 32 fps, the segments are configured at the home position, returning the blade performance to the baseline.

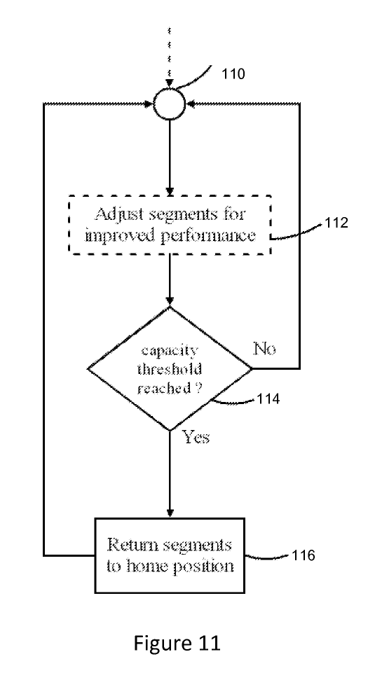

FIG. 11 is a flow chart showing basic operation of the processor as the blade reaches rated capacity. The blade segments are adjusted to improve blade performance as shown by block 112. It should be understood that a variety techniques may be used to determine the segment configuration. For example, the segment positions may be updated via an iterative process, e.g., as shown in FIG. 6. The segments may also be moved into a specific configuration based on a variety of conditions, e.g., wind conditions, baseline blade configuration and the like. The rotor speed is monitored and once a capacity threshold is reached, e.g., 90% of rated capacity, the blade segments are returned to the home position as shown by blocks 114 and 116. The process is repeated as necessary to maintain blade performance in acceptable ranges.

It should be understood that many variations are possible based on the disclosure herein. Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

What is claimed is:

1. A wind turbine blade comprising:
a plurality of pivotable blade segments each having a leading edge segment and a trailing edge segment;
a sensor configured to detect a performance condition associated with at least one of the blade segments, and
an actuator configured to pivot the blade segment to change an angle of attack based on the performance condition.

2. The wind turbine blade of claim 1, further comprising at least one sensor associated with each pivotable blade segment.

3. The wind turbine blade of claim 2, further comprising a processor coupled to the sensor, the processor being configured to read the sensor and drive the actuator to change the angle of attack of the blade segment based on the sensor reading.

4. The wind turbine blade of claim 1, wherein the sensor is configured to measure pressures associated with at least one of an upper and lower surface of the blade segment.

5. The wind turbine blade of claim 1, wherein the sensor is configured to measure flow associated with at least one of an upper and lower surface of the blade segment.

6. The wind turbine blade of claim 1, wherein the sensor is configured to measure rotational speed.

7. The wind turbine blade of claim 6, wherein the segments have a home position and the actuator is configured to move the segments to the home position on a condition that the rotational speed exceeds a capacity threshold.

8. The wind turbine blade of claim 1, further comprising a tuburcle coupled to the leading edge segment of at least one blade segment.

9. The wind turbine blade of claim 1, further comprising a main spar disposed along a major axis of the wind turbine blade, the pivotable blade segments being configured to pivot around the main spar.

10. The wind turbine blade of claim 1, wherein each pivotable blade segment has a home position and is adjustable by a number of degrees on either side of the home position.

11. The wind turbine blade of claim 1, wherein blade is configured with four segments configured at 3°, 3°, 6° and 6° above a home position.

12. The wind turbine blade of claim 1, wherein blade is configured with two segments configured at 3° and 6° above a home position.

13. The wind turbine blade of claim 1, further comprising a left and right fence associated with each pivotable blade segment.

14. A method of improving the performance of a wind turbine blade, the method comprising:
providing a wind turbine blade with a plurality of pivotable blade segments each having a leading edge segment and a trailing edge segment;
detecting a performance condition associated with at least one of the blade segments, and
changing an angle of attack of the blade segment based on the performance condition.

15. The method of claim 14, further comprising measuring pressures associated with at least one of an upper and lower surface of the blade segment to determine the performance condition.

16. The method of claim 14, further comprising measuring flow associated with at least one of an upper and lower surface of the blade segment to determine the performance condition.

17. The method of claim 14, further comprising measuring rotational speed to determine the performance condition.

18. The method of claim 14, wherein the segments have a home position and segments are moved to the home position on a condition that the rotational speed exceeds a capacity threshold.

19. The method of claim 14, wherein each pivotable blade segment has a home position and is adjustable by a number of degrees on either side of the home position.

20. The method of claim 14, wherein blade is configured with four segments initially configured at 3°, 3°, 6° and 6° above a home position.

21. The method of claim 14, wherein blade is configured with two segments initially configured at 3° and 6° above a home position.

22. The method of claim 14, further comprising providing a left and right fence associated with each pivotable blade segment.

23. A wind turbine blade comprising:
a plurality of pivotable blade segments each having a leading edge segment and a trailing edge segment, each segment having a home position;
a sensor configured to detect a performance condition associated with at least one of the blade segments, and
an actuator configured to pivot the blade segment to change an angle of attack to improve blade performance based on the performance condition, the actuator being configured to move to the segments to the home position on a condition that the blade performance exceeds a capacity threshold.

24. A method of generating power using a wind turbine blade, the method comprising:
providing a wind turbine blade with a plurality of pivotable blade segments each having a leading edge segment and a trailing edge segment;
detecting a performance condition associated with at least one of the blade segments, and
changing an angle of attack of the blade segment based on the performance condition.

25. A wind turbine blade comprising:
a plurality of blade segments each having a leading edge segment and a trailing edge segment, a portion of the blade generally defining a home position, at least one of the segments being displaced from a home position.

26. The wind turbine blade of claim 25, wherein blade is configured with two segments configured at 3° and 6° above a home position.
